(19) United States
(12) Patent Application Publication
(10) Pub. No.: US 2002/0124011 A1
(43) Pub. Date: Sep. 5, 2002

(54) Methods, systems, and computer program products for communicating with a controller using a database interface

(76) Inventors: Robert W. Baxter, Raleigh, NC (US); Ralph E. Bard, Raleigh, NC (US)

Correspondence Address: MYERS BIGEL SIBLEY & SAJOVEC, PO BOX 37428, RALEIGH, NC, 27627, US

(21) Appl. No.: 09/844,537

(22) Filed: Apr. 27, 2001

Related U.S. Application Data
(60) Provisional application No. 60/272,668, filed on Mar. 1, 2001.

(51) Int. Cl. G06F 12/00

(52) U.S. Cl. 707/200

(57) ABSTRACT

Embodiments of the present invention provide methods, systems, and computer program products for communicating with a controller in real-time by storing a command for the controller in a database. The command may be a command to write a value of a real-time process control variable to the controller or a command to read a value of a real-time process control variable from the controller. Upon detecting the stored command in the database, the stored command is retrieved from the database and sent to the controller.

### CROSS-REFERENCE TO PROVISIONAL APPLICATION

This application claims the benefit of Provisional Application Ser. No. 60/272,668, filed Mar. 1, 2001, entitled Database Communication System, the disclosure of which is hereby incorporated herein by reference in its entirety as if set forth filly herein.

### BACKGROUND OF THE INVENTION

The present invention relates generally to the field of process control systems, and, more particularly, to methods and systems for communicating between a client/user and process controllers.

The process control industry has evolved in recent years due in part to advancements in personal computer technology. With the onset of serial communications, some manufacturers of industrial process controllers and high-end devices have begun to develop their own communication protocols. These protocols, or command sets may provide the end-user with documentation on how to communicate with each manufacturer's controller and/or device. In other words, each software or application developer may be required to write a custom interface, server routine, or driver routine to exchange data with a controller and/or device. Also, the end user may need to use multiple protocols to talk to controllers and/or devices from different manufacturers, which may make networking difficult.

The process control industry may be divided into two major areas: distributive control systems (DCS) and process logic controllers (PLC). FIG. 1 illustrates a DCS architecture that uses a central processor (CPU) with distributed input/output (I/O) modules. In an industrial setting, the CPU typically resides in a central location, such as a control room. The DCS brings field instrument readings into the CPU, completes necessary calculations, and then transmits the output signals from the control room to the appropriate field instrument. Operators and supervisors can view information directly from the CPU via graphical user interface (GUI) screens.

FIG. 2 illustrates a PLC architecture in which PLCs are mounted in locations remote from the control room, but which are typically near the field instruments that the respective PLCs are monitoring and controlling. The PLC control information and results are typically transmitted via a manufacturer's protocol to a PC running a human machine interface (HMI) software package that can display information via text or GUI screens for use by operators and/or supervisors. Under multiple node network protocols, PLCs can share information with each other for monitoring and control purposes.

Advances in microprocessor chip technology have helped to spur the development of HMIs for the process control industry. For example, Microsoft's dynamic data exchange (DDE) technology has been used to develop PC based HMIs. The development of DDE, has generally facilitated increased development of HMI and supervisory control and data acquisition (SCADA) systems for the control software industry. These systems may use the DDE standard method of data exchange to reduce the effects of the different communication protocols. HMI and SCADA systems may provide data access and supervisory control for operators and supervisors to each controller and/or device via a DDE server. In more detail, DDE technology is generally based on memory-to-memory transfer of information and commands. As Microsoft further developed the Windows capability, their DDE technology advanced and the name was changed to Object Linking and Embedding (OLE). The foundation of OLE version 2, now called Component Object Model (COM), may provide a general-purpose mechanism for component integration on Windows platforms. While this early version of COM included some notions of distributed components, more complete support for distribution became available with the distributed component object model (DCOM) specifications and implementations for Windows 95 and Windows NT.

Although the original version of OLE was generally developed primarily for other PC software, such as word processors, spreadsheets, etc., the industrial process control industry began to use OLE. Through collaboration between automation hardware and software suppliers, efforts have been focused to address the specific needs of the industrial process control industry. These advancements have been named OLE for Process Control (OPC) and are generally considered the standard for interface and communication between controllers and devices with HMI or SCADA software. The OPC standard expanded on the original DDE memory-to-memory exchange by creating a standard by which control hardware and software communicate for reading and writing both data and commands.

OPC is based on Microsoft's OLE (Active X), COM, and DCOM technologies. OPC generally consists of a standard set of interfaces, properties, and methods for use in process-control and manufacturing-automation applications. The Active X/COM technologies may define how individual software components can interact and share data. OPC may provide a common interface for communicating with diverse controllers and/or devices, regardless of the controlling software. The organization that manages this standard is the OPC Foundation.

Although the development of OPC has generally provided developers and endusers with a better option for control software development and control interface, the OPC servers run on a Microsoft Windows operating system (OS). The sharing of information outside the control room may not be easily accomplished and may require specialized software provided by software development and/or control companies. The demands of OPC and GUI software may begin to push the minimum requirements of the hardware to a much higher level.

With the development of the World Wide Web, the Internet, and web-based applications, information sharing is not limited to the Windows environment. Many new software packages have been developed that may take advantage of these developments; however, the communication link to the controller and/or device is still typically OPC.

### SUMMARY OF THE INVENTION

Embodiments of the present invention provide methods, systems, and computer program products for communicating with a controller in real-time by storing a command for the controller in a database. The command may be a command to write a value of a real-time process control variable to the controller or a command to read a value of a real-time process control variable from the controller. Upon detecting the stored command in the database, the stored command is retrieved from the database and sent to the controller.

In accordance with further embodiments of the present invention, a response to the retrieved command that was sent to the controller is received, and a status of the command is updated in a command table in the database. In accordance with still further embodiments of the present invention, a current value associated with a realtime process control variable, which was read from the controller, is stored in a tag table.

In accordance with further embodiments of the present invention, the tag table comprises definitions of one or more real-time process control variables (i.e., tags) that are each associated with a monitoring frequency and a current value. A READ command may be periodically sent to a controller to obtain a value of one of the realtime process control variables and the obtained value may be stored as the current value for that real-time process control variable in the tag table.

In accordance with further embodiments of the present invention, a log module table may be provided in the database that comprises one or more of the real-time process control variables defined in the tag table. The tag table may be periodically read to obtain current values for one or more of the real-time process control variables. The age of a current value associated with a real-time process control variable may then be compared with a predefined age threshold to determine if the current value is “fresh” (i.e., the age is less than the predefined age threshold). If the current value for a real-time process control variable is “fresh,” then it is stored in the historical log table. If the current value for the real-time process control variable is not “fresh,” then a READ command may be sent to the controller to obtain the value of the real-time process control variable. Once a “fresh” value is stored in the tag table for a real-time process control variable, the value may then be stored in the historical log table.

In accordance with further embodiments of the present invention, an event module table is provided in the database that comprises definitions of one or more events based on one or more real-time process control variables defined in the tag table. The current value(s) of the real-time process control variables comprising an event are monitored to determine if the event has occurred. If the event has occurred, then a notification method is performed to notify, for example, a client or operator. The values of the real-time process control variables may also be stored in an events log table in the database if the event occurs.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram of a conventional distributive control system (DCS) network;

FIG. 2 is a block diagram of a conventional process logic controller (PLC) network;

FIG. 3 is a high-level block diagram of controller communication systems in accordance with embodiments of the present invention;

FIG. 4 is a detailed block diagram of controller communication systems in accordance with embodiments of the present invention; and

FIGS. 5-8 are flowcharts that illustrate exemplary operations of controller communication systems in accordance with embodiments of the present invention.

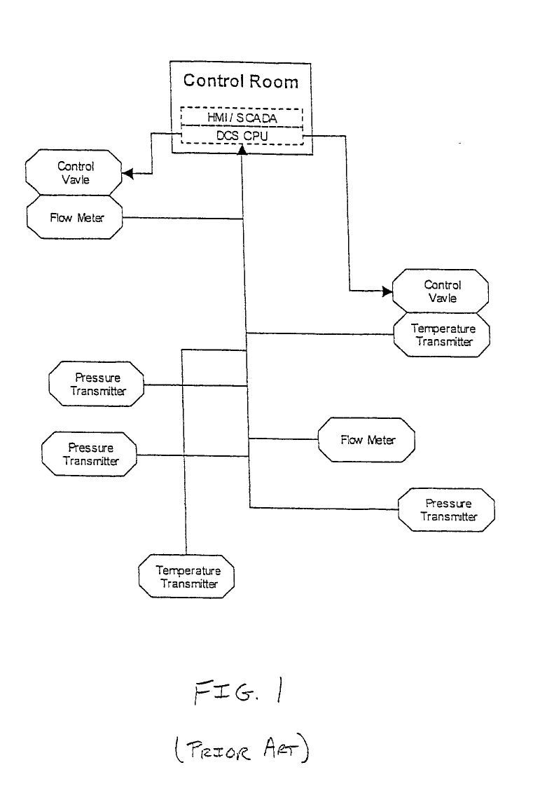

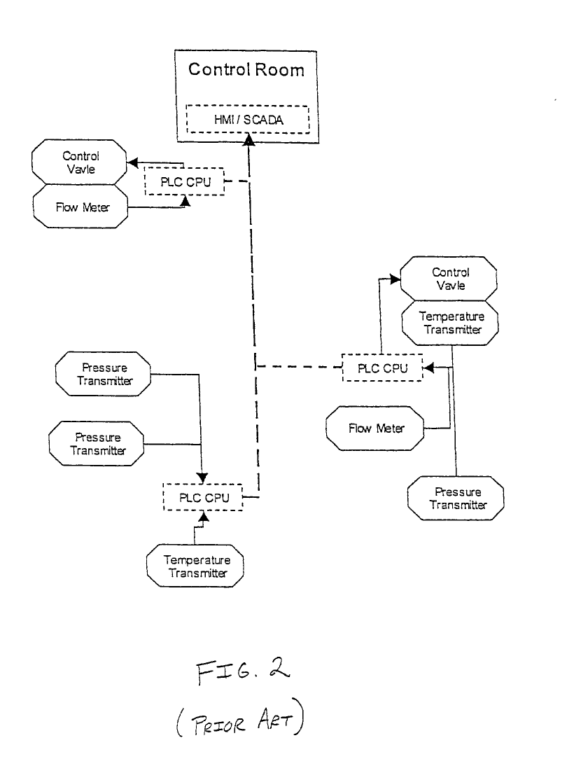

### DETAILED DESCRIPTION OF PREFERRED EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

The present invention may be embodied as methods, systems, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but is not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

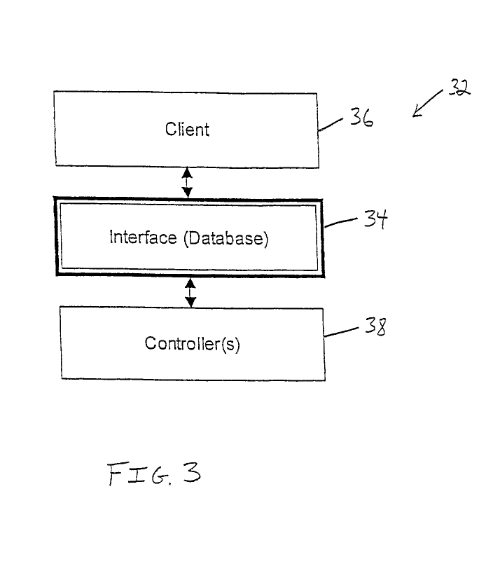

Referring now to FIG. 3, a controller communication system 32, in accordance with embodiments of the present invention, comprises a database interface system 34 that facilitates communication between a client 36 and one or more controllers 38. As used herein, the term “controller” means a unit that has local intelligence, such as a process logic controller (PLC), and is used to monitor and/or control other field or external components by analog or field-bus communications. The term “controller” is also used to refer to devices that have local intelligence and can monitor and control internal and/or external components with its own central processing unit (CPU) (e.g., a gas analyzer). The database interface system 34 may allow the controllers 38 to be monitored, supervised, or controlled by a client 36 by sending commands to the controllers and receiving responses from the controllers through the database interface system 34. Conventional controller communication systems have typically used memory-to-memory information transfer methodologies, which can result in a loss of data should a power failure occur. Advantageously, the database interface system 34 may be configured to preserve the data to be written to and read from the controllers 38 even if a power failure should occur. Moreover, the database interface system 34 may be implemented using conventional database technology, which may allow the client 36 to use readily available database access software tools and networking/communication hardware to communicate with the database interface system 34. A client may also develop their own custom interface screens and/or applications to process data from the controllers 38.

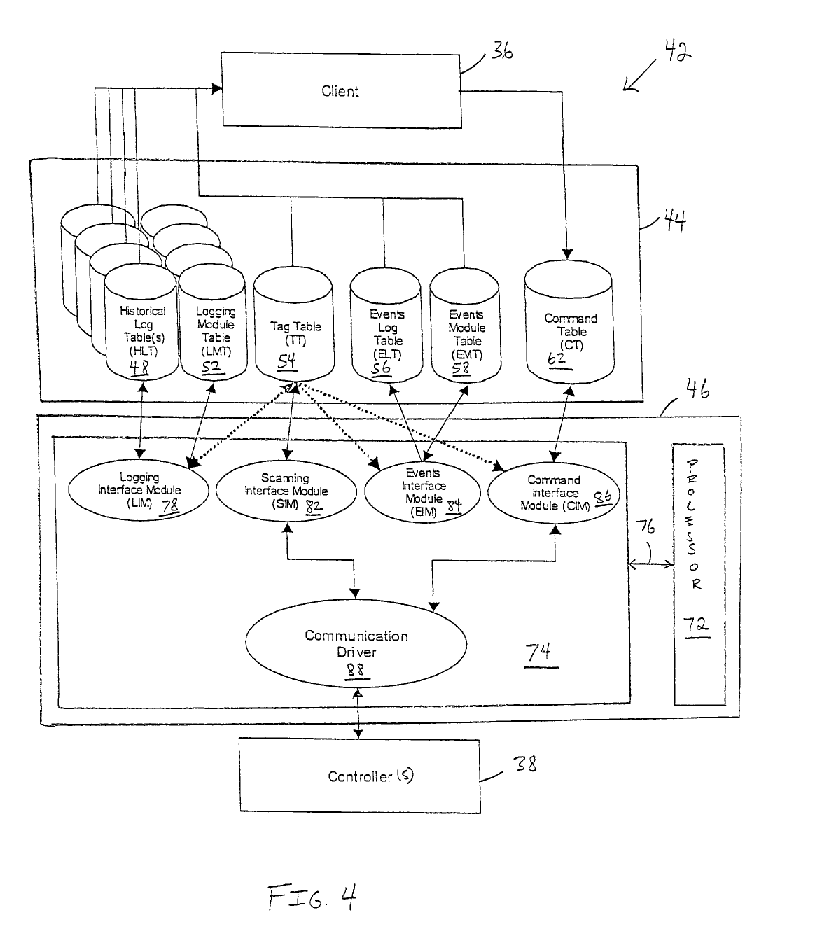

FIG. 4 is a detailed block diagram of a controller communication system 42 in accordance with embodiments of the present invention. As shown in FIG. 4, the controller communication system 42 comprises a client 36, a database system 44, a data processing system 46, and one or more controllers 38. The client 36 may be any user that has permission to access the information in the database system 44. The database system 44, in accordance with embodiments of the present invention, comprises a plurality of tables, which includes, but is not limited to, historical log table(s) 48, logging module table(s) 52, a tag table 54, an event(s) log table 56, an event(s) module table 58, and a command table 62. As used herein, the term “table” means a structure for organizing information, such as, for example, an array of records or a linked list; the term “database” means a collection of one or more tables; and the term “tags” refers to process control variables that are associated with the controllers 38.

Each of the tables comprising the database system 44 will be briefly described hereafter. The historical log table(s) 48 comprise values that have been read for various tags over a predetermined period of time. The logging module table(s) 52 comprise lists of tags for which data are to be logged in the historical log table(s) 48 and define criteria for the tags that specify when values for the tags are to be read and stored in the historical log table(s) 48. The logging criterion for a tag may specify a monitoring frequency, an event trigger, a percent change in value, and/or a client log request. Note that each logging module table 52 may be associated with one of the historical log tables 48. Multiple logging module tables 52 may also be associated with a single historical log table 48.

The tag table 54 defines each tag and specifies each tag's relationship to a memory address inside a controller 38. The tag table 54 may also comprise additional information associated with the tags, such as read/write permissions, scaling factors to be applied to tag values, and/or scan/read rates for periodic monitoring. In addition, the tag table may hold the last scanned/read value for each tag. Thus, the tag table 54 may be accessed to obtain the current (or most recently read) value for each tag.

The event(s) log table 56 comprises data that have been scanned/read for predefined events. The event(s) module table 58 comprises definitions for one or more events based on values of tags defined in the tag table 54. An event may be defined by specifying event criteria for one or more tags, such as threshold values, comparison algorithms (e.g., state change, on, off, mathematical algorithm, etc.). A notification method may also be associated with each event, which defines how the client 36 may be notified. Exemplary notification methods, in accordance with embodiments of the present invention, may include, but are not limited to, screen alarms, audible alarms, light alarms, e-mail, pager call, execution of stored procedure(s), execution of macro(s), etc.). In addition to notification method(s), one or more stored procedure(s) and/or macro(s) may be associated with an event, which are executed when the event occurs.

The command table 62 may be configured to provide a queue for commands from the client 36, such as read and/or write commands. These commands may be retrieved from the command table 62, processed, and then sent to the controller(s) 38.

Still referring to FIG. 4, the data processing system 46 comprises a processor 72 and a memory 74 in accordance with embodiments of the present invention. The processor communicates with the memory 74 via an address/data bus 76. The processor 72 may be, for example, a commercially available or custom microprocessor. The memory 74 is representative of the overall hierarchy of memory devices containing the software and data used to implement the functionality of the controller communication system 42. The memory 74 may include, but is not limited to, the following types of devices: cache, ROM, PROM, EPROM, EEPROM, flash, SRAM, and DRAM.

As shown in FIG. 4, the memory 74 may hold five or more major categories of software and data: a logging interface module (LIM) 78, a scanning interface module (SIM) 82, an events interface module (EIM) 84, a command interface module (CIM) 86, and a communication driver module 88. The LIM 78 may be configured to read each log module table 52 at startup and, based on the logging criteria for the tags, periodically checks the tag table 54 for current data for each tag to be logged. The SIM 82 may be configured to process information (e.g., values for real-time process control variables, success/fail of read and/or write operations, etc.) returned from the controllers 38. In addition, the SIM 82 may be configured to read the tag table 54 at startup to determine if any tags need to be routinely monitored (i.e., periodically scanned or read). For those tags that are to be routinely monitored, the SIM periodically constructs read commands to be sent to the appropriate controller(s) 38 to collect the current tag values. The EIM 84 may be configured to read the events module table 58 at startup and to monitor the status of each tag defined in the events module table 58 for a change in status of a defined event. When an event has a change in status, the EIM 84 may invoke the notification method defined for that event to inform the client 36 of the change in event status. The CIM 86 may be configured to monitor the command table 62 for commands to process. When the CIM 86 detects a command in the command table 62, the CIM 86 may verify that the detected command is a valid command for the destination controller 38 and may then send the command to the communication driver 88. The communication driver 88 may be configured to communicate with the controller(s) 38 using one or more communication protocols supported by the controller(s) 38.

Although FIG. 4 illustrates an exemplary software architecture that may facilitate communication with a controller using a database interface in accordance with embodiments of the present invention, it will be understood that the present invention is not limited to such a configuration, but is intended to encompass any configuration capable of carrying out operations described herein.

Computer program code for carrying out operations of the respective program modules may be written in a high-level programming language, such as C or C++, for development convenience. Nevertheless, some modules or routines may be written in assembly language or even micro-code to enhance performance and/or memory usage. It will be further appreciated that the functionality of any or all of the program modules may also be implemented using discrete hardware components, a single application specific integrated circuit (ASIC), or a programmed digital signal processor or microcontroller.

The present invention is described hereinafter with reference to flowchart and/or block diagram illustrations of methods, systems, and computer program products in accordance with exemplary embodiments of the invention. It will be understood that each block of the flowchart and/or block diagram illustrations, and combinations of blocks in the flowchart and/or block diagram illustrations, may be implemented by computer program instructions. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

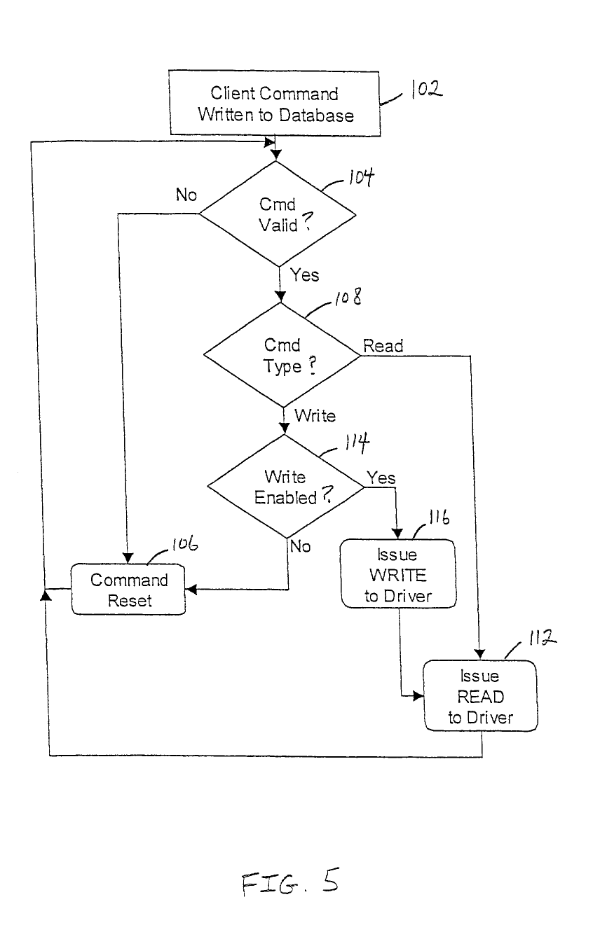

With reference to the flowcharts of FIGS. 5-9, and the block diagram of FIG. 4, exemplary operations of methods, systems, and computer program products for communicating with a controller using a database interface, in accordance with embodiments of the present invention, will be described hereafter. Referring now to FIG. 5, exemplary operations of the CIM 86, in accordance with embodiments of the present invention, begin at block 102 where the client 36 writes a command to the command table 62. In accordance with embodiments of the present invention, the command may be either a WRITE command or a READ command for a real-time process control variable (i.e., a tag) associated with one of the controller(s) 38. At block 104, the CIM 86 determines whether the command that is stored in the command table 62 is a valid request for the destination controller 38. If the command is determined to be invalid, then the command is reset at block 106 and operations continue at block 104 where the CIM 86 waits for another command to be written into the command table 62. If, however, the command is determined to be valid at block 104, then the CIM 86 determines whether the command is a READ or a WRITE command at block 108. If the command is determined to be a READ command at block 108, then the CIM 86 constructs a READ command for the destination controller 38 and forwards this READ command to the communication driver 88 at block 112. The communication driver 88 sends the READ command to the destination controller 38 using an appropriate communication protocol. Next, operations continue at block 104 where the CIM 86 waits for another command to be written into the command table 62.

If the command type is determined to be a WRITE at block 108, then the CIM 86 determines at block 114 if a WRITE operation is allowed for the particular tag identified in the command. If a WRITE operation is not allowed for the tag, then the command is reset at block 106 and operations continue at block 104 where the CIM 86 waits for another command to be written into the command table 62. If, however, the CIM 86 determines at block 114 that a WRITE operation is allowed for the tag, then the CIM 86 constructs a WRITE command for the destination controller 38 and forwards this WRITE command to the communication driver 88 at block 116. The communication driver 88 sends the WRITE command to the destination controller 38 using an appropriate communication protocol. Next, the CIM 86 constructs a READ command for the destination controller 38 and forwards this READ command to the communication driver 88 at block 112. The communication driver 88 sends the READ command to the destination controller 38 using an appropriate communication protocol. The CIM 86 sends a READ command to the controller after the WRITE command to ensure that the WRITE request completed successfully and to provide a quicker response to the client 36. This may be especially useful for those tags that have been defined with relatively long scan/read intervals.

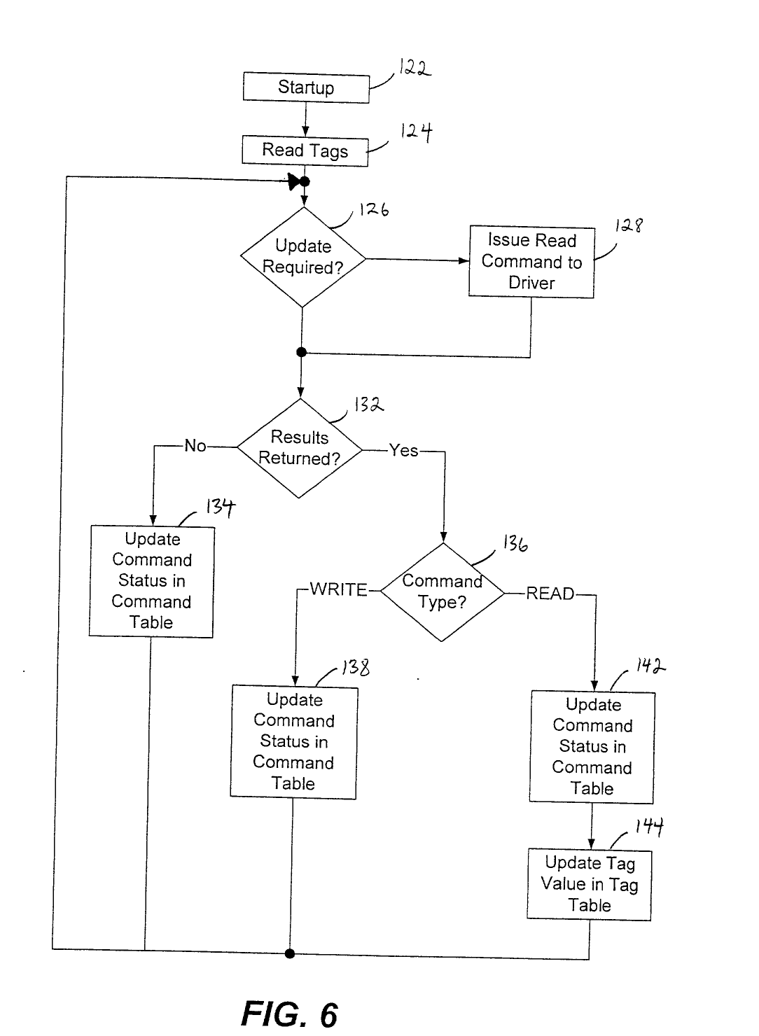

Referring now to FIG. 6, exemplary operations for processing responses from the controller(s) 38, in accordance with embodiments of the present invention, will now be described. Operations begin at block 122 where the controller communication system 42 starts up and then the SIM 82 reads the tag table 54 at block 124. For each of the tags read from the tag table 54, the SIM 82 determines whether the tag is to be periodically updated through routine monitoring at block 126. For those tags that are to be routinely monitored, the SIM 82 periodically constructs READ commands to be sent to the appropriate controller(s) 38 at block 128 to collect the current tag values.

At block 132, the SIM 82 determines whether any of the controller(s) 38 have returned response(s) to READ and/or WRITE commands issued by the CIM 86 and/or the SIM 82. If a response has not been received for a command within a predetermined period of time in which a response should have been received, then the SIM 82 updates the status for that command in the command table 62 as being unprocessed at block 134. If, however, a response is received for a command, then the SIM 82 determines whether the command was a READ command or a WRITE command at block 136. If the response received is for a WRITE command, then the SIM 82 updates the tag table 54 to indicate whether the WRITE command for that particular tag succeeded or failed at block 138. If the response received is for a READ command, then the SIM 82 updates the command table 62 to indicate whether the READ command for that particular tag succeeded or failed at block 142, and also updates the tag table 54 to include the current value of the real-time process control variable associated with that particular tag at block 144. In accordance with particular embodiments of the present invention, the current values for the tags and the status of WRITE and/or READ commands for those tags may be stored in the same table, e.g., the tag table 54 as discussed hereinabove, or, alternatively, the current values for the tags may be stored in one table and the status of WRITE and/or READ commands for those tags may be stored in another table. After blocks 134, 138, and 144, operations continue at block 126 where the SIM 82 checks for any tags that may need to be updated and then block 132 where the SIM 82 checks for additional responses from the controller(s) 38.

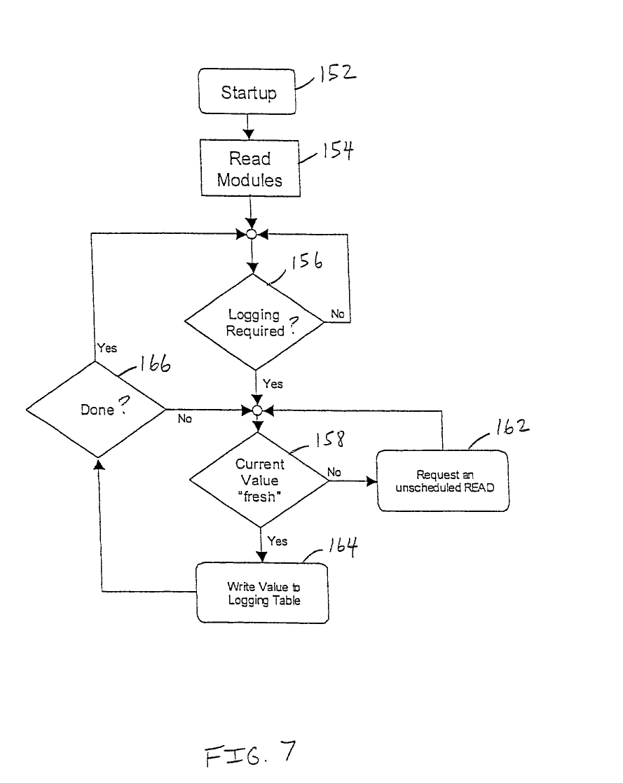

Referring now to FIG. 7, exemplary operations of the LIM 78, in accordance with embodiments of the present invention, will now be described. Operations begin at block 152 where the controller communication system 42 starts up and then the LIM 78 reads the log module table(s) 52 at block 154. As discussed hereinabove, each log module table 52 comprises a list of one or more tags for which data are to be logged in the historical log table(s) 48, and defines criteria for the tags that specify when values for the tags are to be read and stored in the historical log table(s) 48. Thus, at block 156, the LIM 78 determines which of the tags in the log module table(s) 52 need to be logged based on the defined logging criteria (e.g., monitoring frequency, event trigger, percent change in value, and/or client log request).

If logging is required for one or more tags in a log module table 52, then the LIM 78 determines at block 158 whether the current values stored for each of the tags in the tag table 54 is “fresh” by determining the age of a tag value and comparing the age to a predefined age threshold (e.g., is tag value >60 seconds old?). For example, a time stamp or sequence number may be associated with the values read for each of the tags. If the current value for a tag is determined not to be “fresh,” then the LIM 78 requests a READ operation for that tag at block 162 to obtain a new value for the realtime process control variable associated with that tag.

Once a “fresh” value is obtained for a tag, the LIM 78 writes that value to the historical log table 48 associated with the logging module table 52 containing the tag at block 164. Next, the LIM 78 determines whether other tags in the current log module table 52 need to be logged at block 166. If additional tags need to be logged as determined at block 166, then operations continue at block 158 to store values in the historical log table 48 for those tags. Otherwise, operations continue at block 156 where the LIM 78 determines whether additional log module table(s) 52 exist which contain tags to be logged.

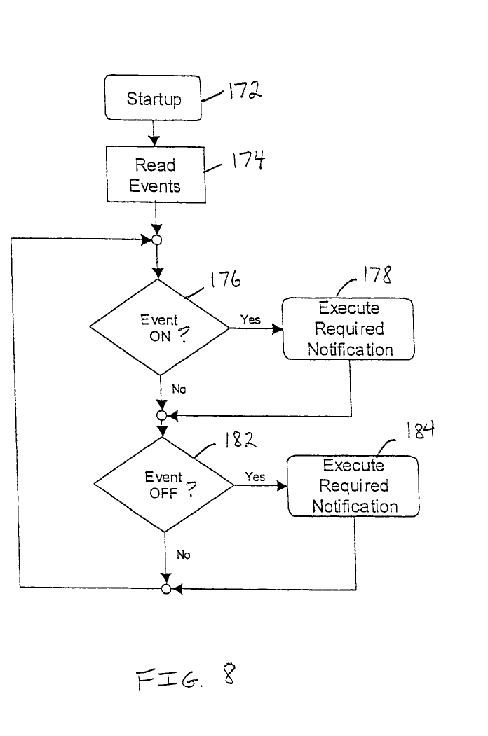

Referring now to FIG. 8, exemplary operations of the EIM 78, in accordance with embodiments of the present invention, will now be described. Operations begin at block 172 where the controller communication system 42 starts up and then the EIM 82 reads the events log table 56 at block 174. The EIM 78 then determines whether a defined event has changed status by monitoring the status of each tag comprising the event. In accordance with embodiments of the present invention, an event may be viewed as turning “ON” when the tags comprising the event take on values that satisfy the event criteria, and an event may be viewed as turning “OFF” when one or more of the tags comprising the event take on values such that the event criteria are no longer satisfied.

Thus, at block 176, the EIM 84 determines whether an event has turned ON. If the EIM 84 determines that the event has turned ON, then the EEM 84 executes any notification method associated with the event at block 178 to notify the client 36 of the change in status of the event and may also store the values for the tags comprising the event in the events log table 56. The EIM 84 may also execute any stored procedure(s) and/or macro(s) that have been associated with the event. The EIM 84 may also determine whether an event has turned OFF at block 182. If the EIM 84 determines that the event has turned OFF, then the EIM 84 executes the notification method associated with the event at block 184 to notify the client 36 of the change in status of the event and may also store the values for the tags comprising the event in the events log table 56. The EIM 84 may also execute any stored procedure(s) and/or macro(s) that have been associated with the event. Operations continue at block 176 where the EIM 84 continues to monitor the tags defined for the various events in the events module table 58. It will be understood that although blocks 176 and 182 are shown in serial, the operations associated therewith may alternatively be performed in parallel.

The flowcharts of FIGS. 4-8 illustrate the architecture, functionality, and operations of a possible implementation of the data processing system 46 software. In this regard, each block represents a module, segment, or portion of code, which comprises one or more executable instructions for implementing the specified logical function(s). It should also be noted that in some alternative implementations, the functions noted in the blocks may occur out of the order noted in FIGS. 4-8. For example, two blocks shown in succession may in fact be executed substantially concurrently or the blocks may sometimes be executed in the reverse order, depending on the functionality involved.

From the foregoing it can readily be seen that, in accordance with embodiments of the present invention, a controller communication system may comprise a database system interface, which is operating system independent and comprises a plurality of interface modules that cooperate with tables to provide functionality to the database and to facilitate transfer of information to and from one or more controllers or devices. By using common database structures, clients can access the data stored in the database system via, for example, an open database compliance (ODBC) connection, a Java database compliance (JDBC) connection, direct drivers, or other conventional database access methods. Information may, therefore, be monitored and viewed by operators locally and/or supervisors and managers remotely. The records stored in the tables comprising the database system may be made read only to protect the integrity of the data. Security permissions may be defined to ensure that only select operators or personnel are allowed to write commands to the controllers and/or devices using the database interface system.

Thus, the use of a database as the interface mechanism by which information, data, and commands are exchanged between clients and controllers and/or devices may allow clients to use conventional software and/or hardware packages to process the data stored in the database system. By allowing for the use of conventional software and/or hardware packages through which a client may develop GUI applications to process the data stored in the database system, the client's software development costs, employee-training costs, and system support costs may be reduced.

Moreover, embodiments of the database system interface may allow clients to interact with a controller and/or device and may allow audit trails to be maintained for transactions between clients and controllers and/or devices. The database system interface may also be configured to provide functionality typically provided by existing HMI and/or SCADA software.

In concluding the detailed description, it should be noted that many variations and modifications can be made to the preferred embodiments without substantially departing from the principles of the present invention. All such variations and modifications are intended to be included herein within the scope of the present invention, as set forth in the following claims.

We claim:

1. A method of communicating with a controller in real-time, comprising:
storing a command for the controller in a database, wherein the command is selected from the group of commands consisting of a write command that is configured to write a value of a real-time process control variable to the controller and a read command that is configured to read a value of a real-time process control variable from the controller;
detecting the stored command in the database;
retrieving the stored command from the database responsive to detecting the stored command; and
sending the retrieved command to the controller.

2. The method of claim 1, wherein retrieving the stored command comprises:
verifying that the stored command is a valid command for the controller.

3. The method of claim 1, wherein sending the retrieved command to the controller comprises sending a write command that is configured to write a first value of a first real-time process control variable to the controller, the method further comprising:
sending a read command that is configured to read the first value of the first real-time process control variable to the controller responsive to sending the write command that is configured to write the first value of the first real-time process control variable to the controller.

4. The method of claim 1, further comprising:
receiving a response from the controller responsive to sending the retrieved command to the controller; and
updating a status of the retrieved command sent to the controller in a command table in the database to indicate whether the retrieved command sent to the controller succeeded or failed.

5. The method of claim 4, wherein sending the retrieved command to the controller comprises sending a read command that is configured to read a first value of a first real-time process control variable from the controller, the method further comprising:
updating a current value associated with the first real-time process control variable in a tag table in the database with the first value of the first real-time process control variable read from the controller responsive to receiving the response from the controller.

6. The method of claim 1, further comprising:
providing a tag table in the database that comprises definitions of a plurality of real-time process control variables, wherein each of the plurality of real-time process control variables is associated with a monitoring frequency and a current value;
periodically sending a read command that is configured to read a value of a real-time process control variable for respective ones of the plurality of real-time process control variables from the controller based on the respective monitoring frequencies; and
updating the respective current values for respective ones of the plurality of real-time process control variables with the respective values of the real-time process control variables read from the controller.

7. The method of claim 6, further comprising:
providing a log module table in the database that comprises a list of at least one of the real-time process control variables defined in the tag table, wherein the at least one real-time process control variable is associated with a logging criterion; and
periodically reading the tag table for the at least one real-time process control variable in the log module table to obtain a current value associated therewith based on the logging criterion.

8. The method of claim 7, further comprising:
comparing an age of the current value associated with the at least one real-time process control variable with a predefined age threshold;
storing the current value for the at least one real-time process control variable in a historical log table if the age of the current value associated with the at least one real-time process control variable does is less than the predefined age threshold; and
sending a read command that is configured to read a value of the at least one real-time process control variable from the controller if the current value for the at least one real-time process control variable is greater than or equal to the predefined age threshold.

9. The method of claim 7, wherein the logging criterion is selected from the group consisting of a monitoring frequency, an event trigger, a percent change in value, and a client request.

10. The method of claim 6, further comprising:
providing an event module table in the database that comprises a definition of at least one event based on at least one of the real-time process control variables defined in the tag table, wherein the at least one event is associated with at least one of a notification method and a stored procedure;
monitoring the current value of the at least one real-time process control variable to determine if the at least one event has occurred; and
performing at least one of the notification method and the stored procedure if the at least one event has occurred.

11. The method of claim 10, further comprising:
providing an event log table in the database; and
saving the current value of the at least one real-time process control variable in the event log table if the at least one event has occurred.

12. A system for communicating with a controller in real-time, comprising:
means for storing a command for the controller in a database, wherein the command is selected from the group of commands consisting of a write command that is configured to write a value of a real-time process control variable to the controller and a read command that is configured to read a value of a real-time process control variable from the controller;
means for detecting the stored command in the database;
means for retrieving the stored command from the database responsive to detecting the stored command; and
means for sending the retrieved command to the controller.

13. The system of claim 12, wherein the means for retrieving the stored command comprises:
means for verifying that the stored command is a valid command for the controller.

14. The system of claim 12, wherein the means for sending the retrieved command to the controller comprises means for sending a write command that is configured to write a first value of a first real-time process control variable to the controller, the system further comprising:
means for sending a read command that is configured to read the first value of the first real-time process control variable to the controller responsive to the means for sending the write command that is configured to write the first value of the first real-time process control variable to the controller.

15. The system of claim 12, further comprising:
means for receiving a response from the controller responsive to sending the retrieved command to the controller; and
means for updating a status of the retrieved command sent to the controller in a command table in the database to indicate whether the retrieved command sent to the controller succeeded or failed.

16. The system of claim 15, wherein the means for sending the retrieved command to the controller comprises means for sending a read command that is configured to read a first value of a first real-time process control variable from the controller, the system further comprising:
means for updating a current value associated with the first real-time process control variable in a tag table in the database with the first value of the first real-time process control variable read from the controller responsive to the means for receiving the response from the controller.

17. The system of claim 12, further comprising:
means for providing a tag table in the database that comprises definitions of a plurality of real-time process control variables, wherein each of the plurality of real-time process control variables is associated with a monitoring frequency and a current value;
means for periodically sending a read command that is configured to read a value of a real-time process control variable for respective ones of the plurality of real-time process control variables from the controller based on the respective monitoring frequencies; and
means for updating the respective current values for respective ones of the plurality of real-time process control variables with the respective values of the real-time process control variables read from the controller.

18. The system of claim 17, further comprising:
means for providing a log module table in the database that comprises a list of at least one of the real-time process control variables defined in the tag table, wherein the at least one real-time process control variable is associated with a logging criterion; and
means for periodically reading the tag table for the at least one real-time process control variable in the log module table to obtain a current value associated therewith based on the logging criterion.

19. The system of claim 18, further comprising:
means for comparing an age of the current value associated with the at least one real-time process control variable with a predefined age threshold;
means for storing the current value for the at least one real-time process control variable in a historical log table if the age of the current value associated with the at least one real-time process control variable does is less than the predefined age threshold; and
means for sending a read command that is configured to read a value of the at least one real-time process control variable from the controller if the current value for the at least one real-time process control variable is greater than or equal to the predefined age threshold.

20. The system of claim 18, wherein the logging criterion is selected from the group consisting of a monitoring frequency, an event trigger, a percent change in value, and a client request.

21. The system of claim 17, further comprising:
means for providing an event module table in the database that comprises a definition of at least one event based on at least one of the real-time process control variables defined in the tag table, wherein the at least one event is associated with at least one of a notification method and a stored procedure;
means for monitoring the current value of the at least one real-time process control variable to determine if the at least one event has occurred; and
means for performing at least one of the notification method and the stored procedure if the at least one event has occurred.

22. The system of claim 21, further comprising:
means for providing an event log table in the database; and
means for saving the current value of the at least one real-time process control variable in the event log table if the at least one event has occurred.

23. A computer program product for communicating with a controller in real-time, comprising:
a computer readable program medium having computer readable program code embodied therein, the computer readable program code comprising:
computer readable program code for storing a command for the controller in a database, wherein the command is selected from the group of commands consisting of a write command that is configured to write a value of a real-time process control variable to the controller and a read command that is configured to read a value of a real-time process control variable from the controller;
computer readable program code for detecting the stored command in the database;
computer readable program code for retrieving the stored command from the database responsive to detecting the stored command; and
computer readable program code for sending the retrieved command to the controller.

24. The computer program product of claim 23, wherein the computer readable program code for retrieving the stored command comprises:
computer readable program code for verifying that the stored command is a valid command for the controller.

25. The computer program product of claim 23, wherein the computer readable program code for sending the retrieved command to the controller comprises computer readable program code for sending a write command that is configured to write a first value of a first real-time process control variable to the controller, the computer program product further comprising:
computer readable program code for sending a read command that is configured to read the first value of the first real-time process control variable to the controller responsive to the computer readable program code for sending the write command that is configured to write the first value of the first real-time process control variable to the controller.

26. The computer program product of claim 23, further comprising:
computer readable program code for receiving a response from the controller responsive to sending the retrieved command to the controller; and
computer readable program code for updating a status of the retrieved command sent to the controller in a command table in the database to indicate whether the retrieved command sent to the controller succeeded or failed.

27. The computer program product of claim 26, wherein the computer readable program code for sending the retrieved command to the controller comprises computer readable program code for sending a read command that is configured to read a first value of a first real-time process control variable from the controller, the computer program product further comprising:
computer readable program code for updating a current value associated with the first real-time process control variable in a tag table in the database with the first value of the first real-time process control variable read from the controller responsive to the computer readable program code for receiving the response from the controller.

28. The computer program product of claim 23, further comprising:
computer readable program code for providing a tag table in the database that comprises definitions of a plurality of real-time process control variables, wherein each of the plurality of real-time process control variables is associated with a monitoring frequency and a current value;
computer readable program code for periodically sending a read command that is configured to read a value of a real-time process control variable for respective ones of the plurality of real-time process control variables from the controller based on the respective monitoring frequencies; and
computer readable program code for updating the respective current values for respective ones of the plurality of real-time process control variables with the respective values of the real-time process control variables read from the controller.

29. The computer program product of claim 28, further comprising:
computer readable program code for providing a log module table in the database that comprises a list of at least one of the real-time process control variables defined in the tag table, wherein the at least one real-time process control variable is associated with a logging criterion; and
computer readable program code for periodically reading the tag table for the at least one real-time process control variable in the log module table to obtain a current value associated therewith based on the logging criterion.

30. The computer program product of claim 29, further comprising:
computer readable program code for comparing an age of the current value associated with the at least one real-time process control variable with a predefined age threshold;
computer readable program code for storing the current value for the at least one real-time process control variable in a historical log table if the age of the current value associated with the at least one real-time process control variable does is less than the predefined age threshold; and
computer readable program code for sending a read command that is configured to read a value of the at least one real-time process control variable from the controller if the current value for the at least one real-time process control variable is greater than or equal to the predefined age threshold.

31. The computer program product of claim 29, wherein the logging criterion is selected from the group consisting of a monitoring frequency, an event trigger, a percent change in value, and a client request.

32. The computer program product of claim 28, further comprising:
computer readable program code for providing an event module table in the database that comprises a definition of at least one event based on at least one of the real-time process control variables defined in the tag table, wherein the at least one event is associated with at least one of a notification method and a stored procedure;
computer readable program code for monitoring the current value of the at least one real-time process control variable to determine if the at least one event has occurred; and
computer readable program code for performing at least one of the notification method and the stored procedure if the at least one event has occurred.

33. The computer program product of claim 32, further comprising:
computer readable program code for providing an event log table in the database; and
computer readable program code for saving the current value of the at least one real-time process control variable in the event log table if the at least one event has occurred.
